(19) United States
(12) Patent Application Publication
(10) Pub. No.: US 2024/0338422 A1
(43) Pub. Date: Oct. 10, 2024

(54) Biograb (Biodigitalization and BioBlockchainAdaptation)

(71) Applicants: Jackson Freeman, Pittsburgh, PA (US); Vareril Konovalov, Moscow (RU)

(72) Inventors: Jackson Freeman, Pittsburgh, PA (US); Vareril Konovalov, Moscow (RU)

(21) Appl. No.: 18/132,400

(22) Filed: Apr. 9, 2023

(51) Int. Cl. G06F 21/10; H04L 9/00; H04L 9/32

(52) U.S. Cl. CPC G06F 21/1014; H04L 9/3213; H04L 9/50

(57) ABSTRACT

This invention is aimed at applying blockchain and NFT (Non-Fungible Tokens) technologies in a new field—the tokenization of biological objects such as humans, plants, animals, microorganisms, or biological samples, their characteristics, and properties. The technical result is the enhancement of personal data protection and property rights for biological objects, as well as the emergence of a new method for representing biological objects in digital environments. The method describes ways of identification, verification, and digitalization of these objects using blockchain and NFT technologies. The method discloses the principle of associating each biological object with a unique NFT (Non-Fungible Token), which serves as a digital certificate of identity or authenticity of ownership of the biological object. The potential application areas of this invention are diverse, including agriculture, biodiversity, pharmaceuticals, the food industry, scientific research, and virtual environments.

### BACKGROUND OF THE INVENTION

Currently, the processing of identifying information about an individual and their attributes is carried out through the creation of data registries hosted on specific local servers/carriers, with the possibility of making changes to the information by data operators. In this context, the owner of personal data has no control over the changes made by the database operators to their personal data. Moreover, there is a security issue where databases are constantly targeted by cyberattacks attempting unauthorized access, copying, alteration, and data destruction. The main problem of centralized systems is that a hacker needs to attack only one place to gain access to the database. In the case of a decentralized system, there is no single point of failure that would allow an attacker to modify the database.

Additionally, for other biological objects besides humans, there are currently no methods of representation and authentication in the digital environment.

Blockchain technology plays a significant role in providing proof of origin for any objects, and can be utilized in a new field—the field of tokenizing biological objects such as humans, animals, plants, microorganisms, or biological samples. When an NFT (Non-Fungible Token) is created, its unique identifier and ownership information are recorded on a blockchain, which is a decentralized and immutable ledger. This blockchain record serves as a tamper-proof and transparent proof of the NFT's (Non-Fungible Token) origin and complete ownership history. Every transaction involving the NFT (Non-Fungible Token) is also recorded on the blockchain, showing the movement of ownership over time.

NFT (Non-Fungible Token) is a smart contract-based technology, and each smart contract, similar to a blockchain wallet, has its own address. Anyone can go to a block explorer, enter an NFT's (Non-Fungible Token) address into the search bar, and easily find the NFT's (Non-Fungible Token) smart contract.

### BRIEF SUMMARY OF THE INVENTION

The invention represents a new method of utilizing blockchain and NFT (Non-Fungible Token) technologies for the digitalization of biological objects such as humans, animals, plants, microorganisms, or biological samples, along with their characteristics and properties, by tokenizing them and creating a unique NFT (Non-Fungible Token) that serves as a digital analogue of the biological object, reflecting it in the digital environment.

### The Method Creates:

a new way of identifying various biological objects such as humans, animals, plants, microorganisms, or biological samples;
a new method for registering rights to any biological objects such as animals, plants, microorganisms, or biological samples;
a new approach for displaying biological objects such as humans, animals, plants, microorganisms, or biological samples in digital environments;
a new method for owning digital analogs of biological objects such as animals, plants, microorganisms, or biological samples.

### BRIEF DESCRIPTION OF THE SEVERAL VIEWS OF THE DRAWING

The disclosed embodiments have other advantages and features which will be more readily apparent from the detailed description, the appended claims. A brief introduction of the FIGURE is below.

FIG. 1 illustrates a method of tokenizing biological objects by associating each biological object with a unique NFT (Non-Fungible Token) using data storage technology through a distributed network.

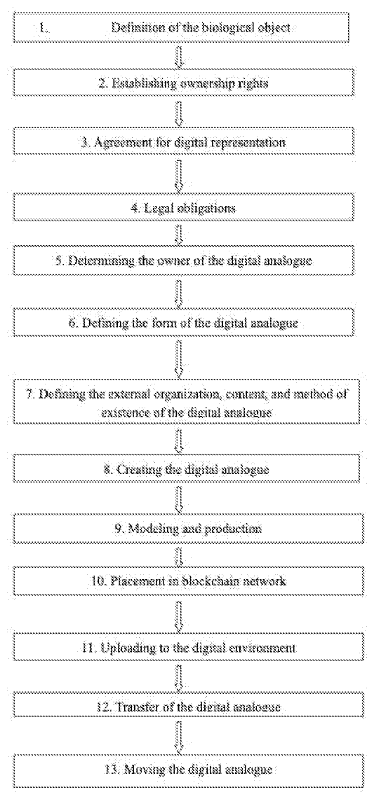

### DETAILED DESCRIPTION OF THE INVENTION

Blockchain technology plays a significant role in providing “proof of provenance” for NFTs (Non-Fungible Tokens). When an NFT (Non-Fungible Token) is created, its unique identifier and ownership information are recorded on a blockchain, which is a decentralized and immutable ledger. This blockchain record serves as a tamper-proof and transparent proof of the NFT's (Non-Fungible Token) origin and entire ownership history. Every transaction involving the NFT (Non-Fungible Token) is also recorded on the blockchain, showing the movement of ownership over time.

NFT (Non-Fungible Token) is a smart contract based technology, and each smart contract, like a blockchain wallet, has its own address. Anyone can go to a block explorer, enter an NFT's address into the search bar and easily find the NFT's (Non-Fungible Token) smart contract. Additionally, the block explorer will show the address that originated the NFT (Non-Fungible Token). If the smart contract address matches the known creator's address, the NFT (Non-Fungible Token) is authentic. If it doesn't match, the NFT (Non-Fungible Token) is not authentic and is not from the purported known creator.

A blockchain operates as a decentralized and immutable ledger, eliminating the need for a central authority or single storage location.

There are multiple (thousands in some cases) copies of the blockchain (the list of all transactions) on different computers in different geographic locations worldwide. Each copy of the blockchain is maintained by different people or groups. Each one of the computers in the network is referred to as a node. All nodes are constantly syncing with each other through a decentralized peer-to-peer network to maintain the integrity of the transaction data.

Every owner (original, interim, and current) and transaction of an NFT (Non-Fungible Token) is recorded on the blockchain. So, when you do a search of an NFT's (Non-Fungible Token) address on a block explorer or check the trading history, you will see the NFT's (Non-Fungible Token) creator, each successive owner, and the dates and amounts of each transaction. Such transactions are immutable (once they're confirmed on the blockchain), as is the nature of blockchain, providing an ironclad chain of title or provenance.

“Immutable” in this context means that transactions placed on the blockchain cannot be changed or deleted after their confirmation. This ensures data security and reliability, as the information stored on the blockchain becomes permanent and unalterable.

“Chain of title” refers to the sequence of documents and records that prove the transfer of ownership rights of an asset from one owner to another. In the context of blockchain, “chain of title” implies that each transaction is recorded on the blockchain, forming a continuous and reliable chain that demonstrates the history of ownership rights transfer of the asset since its creation.

Thus, thanks to its immutability, the blockchain provides a robust and reliable chain of ownership or provenance, making it an ideal tool for confirming the history and authenticity of the object.

The blockchain also provides permanence. Unlike biological objects, NFTs (Non-Fungible Token), under the assumption of a constant distributed network, can not be accidentally damaged or destroyed. They can theoretically remain in pristine condition forever.

The invention represents a new method of utilizing blockchain and NFT (Non-Fungible Token) technologies for the digitalization of biological objects such as humans, animals, plants, microorganisms, or biological samples, along with their characteristics and properties, by tokenizing them and creating a unique NFT (Non-Fungible Token) that serves as a digital analogue of the biological object, reflecting it in the digital environment.

A method of tokenizing biological objects by associating each biological object with a unique NFT (Non-Fungible Token) using data storage technology through a distributed network, comprises at least some or all of the following steps:
definition of the biological object (1) is a selection of a biological object, such as humans plants, animals, microorganisms, or biological samples, for tokenization, by capturing and storing various data points, features, and properties that uniquely identify each biological object;
request for the submission of documents identifying a biological object or the ownership rights to a biological object;
establishing ownership rights (2), which is conducted through verification of the biological object or ownership rights to the biological object;
concluding an agreement for digital representation (3) establishing the obligations of the owner of the property rights or rights to possession, use, and disposal of a biological object and its derivatives, regarding the transfer of the specified biological object into a digital environment. In this context, a digital environment refers to a combination of network software protocols enabling information transmission over blockchain-type networks through various networks, including the Internet, peer-to-peer networks, a set of programs and software platforms providing storage, processing, and presentation of information from databases, including distributed databases, and interface programs facilitating the perception of information by end-users. A digital analogue of a biological object is understood as a digital representation of the biological object within the digital environment, closely resembling the essential properties and characteristics of the actual biological object, enabling its distinction from similar representations and establishing its factual and legal connection to the identified biological object;
legal obligations (4) involve the conclusion of a legal agreement between the rights holder of the biological object and the party conducting the digitization of the biological object, defining the obligations of the agreement's parties and the distribution of rights to the newly created NFT (Non-Fungible Token).
determining the owner of the digital analogue (5) of a biological object or other possessor of the digital analogue of a biological object;
defining the form of the digital analogue (6) of a biological object, including the selection of a specific type of NFT (Non-Fungible Token);
defining the external organization, content, and method of existence of the digital analogue (7): including definition of the method of transferring the digital analogue of a biological object onto the blockchain network, as well as the identification of the external organization, content, and manner of existence of the digital analogue of the biological object in a specific form on the blockchain network, achieved through data recording in any blockchain-compatible format, including in the form of NFT (Non-Fungible Token);
creating a digital analogue (8) of a biological object that will represent the biological object, its properties, and characteristics in the digital environment of the blockchain network;
modeling and production (9) of the form and content of the digital analogue for placement in the digital environment of the blockchain network;
placement in blockchain network (10) of the digital analogue of the biological object;
uploading to the digital environment (11) of the digital analogue of the biological object for subsequent storage and access provision;
transfer of the digital analogue (12) of the biological object/its records to the owner of the object;
moving the digital analogue (13) of the biological object within the digital environment of the blockchain network to the owner or another rights holder of the digital analogue of the biological object, in order to enable them to realize their rights over the object.

Once digitized, the biological objects can be identified and authenticated through the use of blockchain and NFT technology. Each biological object could be associated with a unique NFT, acting as a digital certificate of authenticity and ownership.

The potential applications of this invention could be vast, for example:
in agriculture and biodiversity conservation, it could be used to track and identify rare or endangered species, preserving their genetic information and ensuring their proper conservation efforts;
in pharmaceutical research, it could help track and authenticate biological samples, ensuring the integrity and accuracy of research data;
in the food industry, it could be used to trace the origin and quality of agricultural products, ensuring food safety and supply chain transparency;
in scientific research, it could facilitate data sharing and collaboration by securely recording and validating the origin and characteristics of biological samples;
in virtual worlds that represent an online environment that simulates the real world in which multitudes of people explore the world and interact through their avatars, which are customized representations of the user.

1. A method of tokenizing biological objects by associating each biological object with a unique NFT (Non-Fungible Token) using data storage technology through a distributed network, wherein the method comprises at least some or all of the following steps:
selection of a biological object, such as humans, plants, animals, microorganisms, or biological samples, for tokenization, by capturing and storing various data points, features, and properties that uniquely identify each biological object;
request for the submission of documents identifying a biological object or the ownership rights to a biological object;
verification of the biological object or ownership rights to the biological object;
concluding an agreement with the rights holder of the biological object on the tokenization of the biological object through the creation of its unique NFT (Non-Fungible Token) and the distribution of rights to the newly created object;
the determination of the owner or other possessor of the digital analogue of a biological object;
definition of the method of transferring the digital analogue of a biological object onto the blockchain network, as well as the identification of the external organization, content, and manner of existence of the digital analogue of the biological object in a specific form on the blockchain network, achieved through data recording in any blockchain-compatible format, including in the form of NFT (Non-Fungible Token);
creating a digital analogue of a biological object that will represent the biological object, its properties, and characteristics in the digital environment of the blockchain network;
placing the digital analogue of a biological object on the blockchain network, uploading the digital analogue of a biological object into the digital environment of the blockchain network for subsequent storage and access provision;
transferring the digital analogue of a biological object/its records to the owner of the object.

2. (canceled)

3. (canceled)

4. (canceled)

5. (canceled)

6. (canceled)
